(19) United States
(12) Patent Application Publication
(10) Pub. No.: US 2006/0041409 A1
(43) Pub. Date: Feb. 23, 2006

(54) Method for making a reservoir facies model utilizing a training image and a geologically interpreted facies probability cube

(75) Inventors: Sebastien B. Strebelle, Palo Alto, CA (US); Julian Arthur Thorne, Benicia, CA (US); Andrew William Harding, Danville, CA (US); Marjorie E. Levy, Danville, CA (US); Deyi Xie, San Ramon, CA (US)

Correspondence Address: CHEVRON TEXACO CORPORATION, P.O. BOX 6006, SAN RAMON, CA, 94583-0806, US

(73) Assignee: Chevron U.S.A. Inc.

(21) Appl. No.: 10/923,316

(22) Filed: Aug. 20, 2004

(51) Int. Cl. G06G 7/48

(52) U.S. Cl. 703/10

(57) ABSTRACT

A method for creating a reservoir facies model is disclosed. A S-grid is created which is representative of a subterranean region to be modeled. A training image is constructed which includes a number of facies. The training image captures facies geometry, associations and heterogeneity among the facies. A facies probability cube corresponding to the S-grid is derived from a geological interpretation of the facies distribution within the subterranean region. Finally, a geostatistical simulation, preferably a multiple-point simulation, is performed to create a reservoir facies model which utilizes the training image and facies probability cube and is conditioned to subsurface data and information. Ideally, the facies probability cube is created using an areal depocenter map of the facies which identifies probable locations of facies within the S-grid.

### CROSS-REFERENCE TO RELATED PATENT APPLICATIONS

This application incorporates by reference all of the following co-pending applications:
“Method for Creating Facies Probability Cubes Based Upon Geologic Interpretation,” Ser. No. ______ Attorney Docket No. T-6359, filed herewith.
“Multiple-Point Statistics (MPS) Simulation with Enhanced Computational Efficiency,” Ser. No. ______ Attorney Docket No. T-6411, filed herewith.

### FIELD OF THE INVENTION

The present invention relates generally to methods for constructing reservoir facies models, and more particularly, to an improved method utilizing training images and facies probability cubes to create reservoir facies models.

### BACKGROUND OF THE INVENTION

Reservoir flow simulation typically uses a 3D static model of a reservoir. This static model includes a 3D stratigraphic grid (S-grid) commonly comprising millions of cells wherein each individual cell is populated with properties such as porosity, permeability, and water saturation. Such a model is used first to estimate the volume and the spatial distribution of hydrocarbons in place. The reservoir model is then processed through a flow simulator to predict oil and gas recovery and to assist in well path planning.

In petroleum and groundwater applications, realistic facies modeling is critical to identify new resource development opportunities and to make appropriate reservoir management decisions such as new well drilling. Yet, current practice in facies modeling is mostly based on variogram-based simulation techniques. A variogram is a statistical measure of the correlation between two spatial locations in a reservoir. A variogram is usually determined from well data.

These variogram-based simulation techniques are known to give to a modeler a very limited control on the continuity and the geometry of simulated facies. In general, variogram-based models display much more stochastic heterogeneity than expected when compared with conceptual depositional models provided by a geologist.

Variogram-based techniques may provide reasonable predictions of the subsurface architecture in the presence of closely spaced and abundant data, but these techniques fail to adequately model reservoirs with sparse data collected at a limited number of wells. This is commonly the case, for example, in deepwater exploration and production.

A more recent modeling approach, referred to as multiple-point statistics simulation, or MPS, has been proposed by Guardiano and Srivastava, Multivariate Geostatistics: Beyond Bivariate Moments: Geostatistics-Troia, in Soares, A., ed., Geostatistics-Troia: Kluwer, Dordrecht, V. 1, p. 133-144, (1993). MPS simulation is a reservoir facies modeling technique that uses conceptual geological models as 3D training images to generate geologically realistic reservoir models. Reservoir models utilizing MPS methodologies have been quite successful in predicting the likely presence and configurations of facies in reservoir facies models.

Numerous others publications have been published regarding MPS and its application. Caers, J. and Zhang, T., 2002, Multiple-point Geostatistics: A Quantitative Vehicle for Integrating Geologic Analogs into Multiple Reservoir Models, in Grammer, G. M et al., eds., Integration of Outcrop and Modern Analog Data in Reservoir Models: MPG Memoir. Strebelle, S., 2000, Sequential Simulation Drawing Structures from Training Images: Doctoral Dissertation, Stanford University. Strebelle, S., 2002, Conditional Simulation of Complex Geological Structures Using Multiple-Point Statistics: Mathematical Geology, V. 34, No. 1. Strebelle, S., Payrazyan, K., and J. Caers, J., 2002, Modeling of a Deepwater Turbidite Reservoir Conditional to Seismic Data Using Multiple-Point Geostatistics, SPE 77425 presented at the 2002 SPE Annual Technical Conference and Exhibition, San Antonio, September 29-October 2. Strebelle, S. and Journel, A, 2001, Reservoir Modeling Using Multiple-Point Statistics: SPE 71324 presented at the 2001 SPE Annual Technical Conference and Exhibition, New Orleans, September 30-October 3. The MPS technique incorporates geological interpretation into reservoir models, which is important in areas with few drilled wells. The MPS simulation reproduces expected facies structures using a fully explicit training image rather than a variogram. The training images describe the geometrical facies patterns believed to be present in the subsurface.

Training images used in MPS simulations do not need to carry any spatial information of the actual field; they only reflect a prior geological conceptual model. Traditional object-based algorithms, freed of the constraint of data conditioning, can be used to generate such images. MPS simulation consists then of extracting patterns from the training image, and anchoring them to local data, i.e. well logs and seismic data.

A paper by Caers, J., Strebelle, S., and Payrazyan, K., Stochastic Integration of Seismic Data and Geologic Scenarios: A West Africa Submarine Channel Saga, The Leading Edge, March 2003, describes how seismically-derived facies probability cubes can be used to further enhance conventional MPS simulation in creating reservoir models including facies. A probability cube is created which includes estimates of the probability of the presence of particular facies for each cell in a reservoir model. These probabilities, along with information from training images, are then used with a particular MPS algorithm, referred to as SNESIM (Single Normal Equation Simulation), to construct a reservoir facies model.

The aforementioned facies probability cubes were created from seismic data using a purely mathematical approach, which is described in greater detail in a paper to Scheevel, J. R., and Payrazyan, K., entitled Principal Component Analysis Applied to 3D Seismic Data for Reservoir Property Estimation, SPE 56734, 1999. Seismic data, in particular seismic amplitudes, are evaluated using Principal Component Analysis (PCA) techniques to produce eigenvectors and eigenvalues. Principal components then are evaluated in an unsupervised cluster analysis. The clusters are correlated with known properties from well data, in particular, permeability, to estimate properties in cells located away from wells. The facies probability cubes are derived from the clusters.

Both variogram-based simulations and the MPS simulation utilizing the mathematically-derived facies probability cubes share a common shortcoming. Both simulations methods fail to account for valuable information that can be provided by geologist/geophysicist's interpretation of a reservoir's geological setting based upon their knowledge of the depositional geology of a region being modeled. This information, in conjunction with core and seismic data, can provide important information on the reservoir architecture and the spatial distribution of facies in a reservoir model.

The present invention provides a method for overcoming the above described shortcoming in creating reservoir facies models.

### SUMMARY OF THE INVENTION

The present invention provides a method for creating a reservoir facies model. A S-grid is created which is representative of a subterranean region to be modeled. A training image is created which includes a plurality of facies. Also, a facies probability cube is created. The facies probability cube is created based upon a geological interpretation of the facies distribution within the subterranean region. Finally, a geostatistical simulation is performed which utilizes the training image and the facies probability cube to create a reservoir facies model. Most preferably, the geostatistical simulation uses multiple-point statistics.

The training image reflects interpreted facies types, their geometry, associations and heterogeneities. The facies probability cube captures information regarding the relative spatial distribution of facies in the S-grid based upon geologic depositional information and conceptualizations. The geostatistical simulation derives probabilities for the existence of facies at locations within the S-grid from the training image. These probabilities are combined with probabilities from the facies probability cube, ideally using a permanence of ratio methodology.

Uncertainty in assumptions made in making the training images and in creating the facies probability cube may be modeled. For example, additional geostatistical simulations can be performed using a single training image with numerous different facies probability cubes to capture a range of uncertainty in the distribution of the facies due to assumptions made in creating the facies probability cube. Alternatively, additional geostatistical simulations can be performed using a single facies probability cube with numerous versions of the training image. In this case, uncertainty related to the choices made in making the training image can be captured. The facies probability cube is preferably created utilizing an areal depocenter map of the facies which identifies probable locations of facies within the S-grid.

It is an object of the present invention to create a reservoir facies model using geostatistical simulation employing a training image of facies and a facies probability cube which is derived through a geological interpretation of the spatial distributions of facies in a S-grid.

### BRIEF DESCRIPTION OF THE DRAWINGS

These and other objects, features and advantages of the present invention will become better understood with regard to the following description, pending claims and accompanying drawings where:

FIG. 1 is a flowchart describing a preferred workflow for constructing a reservoir facies model made in accordance with the present invention;

FIG. 2 shows how geological interpretation is used to create 3D training images which are then conditioned to available data to create a multiple-point geostatistics model;

FIGS. 3A-B show respective slices and cross-sections through a S-grid showing the distribution of estimated facies;

FIGS. 4A-E, respectively, show a training image and facies components which are combined to produce the training image;

FIGS. 5A-C depict relationship/rules between facies;

FIGS. 6A-C illustrates vertical and horizontal constraints between facies;

FIG. 7 is a schematic drawing of a facies distribution modeling technique used to create a geologically interpreted facies probability cube, and ultimately, a facies reservoir model;

FIGS. 8A-B illustrate a series of facies assigned to a well and a corresponding facies legend;

FIGS. 9A-B shows an undulating vertical section taken from an S-grid with facies assigned to four wells located on the section and that section after being flattened;

FIG. 10 shows polygons which are digitized on to a vertical section which is representative of a modeler's conception of the geologic presence of facies along that section;

FIG. 11 is a vertical proportion graph showing estimates of the proportion of facies along each layer of a vertical section wherein the proportion on each layer adds up to 100%;

FIG. 12 shows an exemplary global vertical proportion graph; and

FIG. 13 illustrates a depocenter trend map containing overlapping facies depocenter regions;

FIGS. 14A-D shows digitized depocenter regions for four different facies which suggest where facies are likely to be found in an areal or map view of the S-grid;

FIGS. 15A-F show the smoothing of a depocenter region into graded probability contours using a pair of boxcar filters;

FIGS. 16A-B show dominant and minimal weighting graphs used in creating weighted vertical facies proportion graphs;

FIG. 17 shows a vertical cross-section of an S-grid used in creating the weighted vertical facies proportion graph; and

FIG. 18 shows a weighted vertical facies proportion graph.

### DETAILED DESCRIPTION OF THE INVENTION

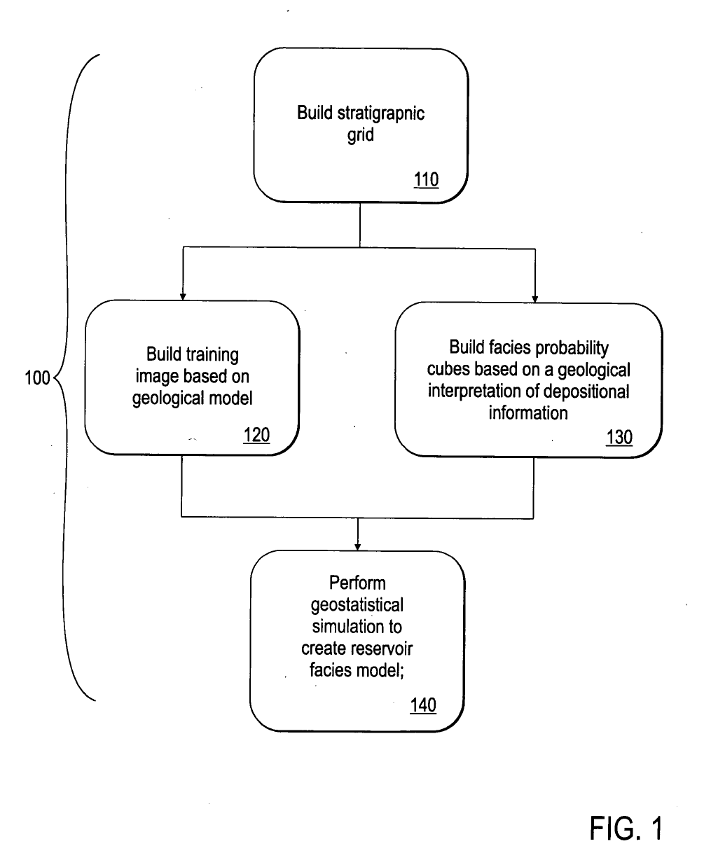

FIG. 1 shows a workflow 100, made in accordance with a preferred embodiment of the present invention, for creating a reservoir facies model. In particular, the workflow uses a training image, in conjunction with a geologically-interpreted facies probability cube as a soft constraint, in a geostatistical simulation to create a reservoir facies model. A first step 110 in the workflow is to build a S-grid representative of a subsurface region to be modeled. The S-grid geometry relates to reservoir stratigraphic correlations. Training images are created in step 120 which reflect interpreted facies types, their geometry, associations and heterogeneities. A geologically-interpreted facies probability cube is then created in step 130. This facies probability cube captures information regarding the relative spatial distribution of facies in the S-grid based upon geologic depositional information and conceptualizations. The facies probability cube ideally honors local facies distribution information such as well data. A geostatistical simulation is performed in step 140 to create a reservoir facies model.

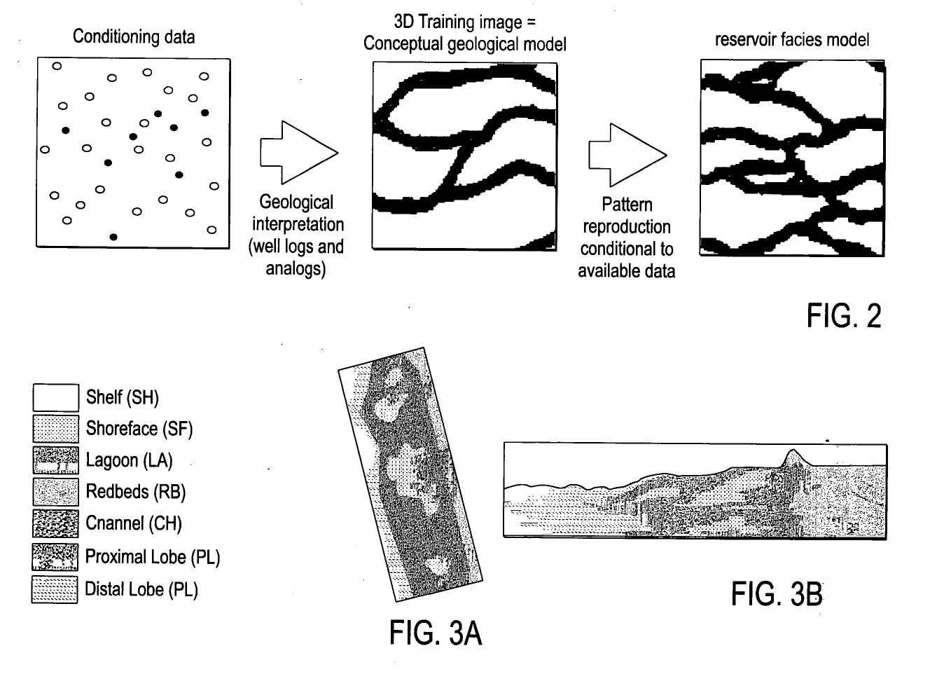

FIG. 2 illustrates that conditioning data, such as well logs and analogs, may be used in a geological interpretation to create the 3D training image or conceptual geological model. The training image uses pattern reproduction, preferably by way of the MPS simulation, to condition the available data into a reservoir facies model. The geostatistical simulation utilizes the aforementioned training image and geologically-interpreted facies probability cube and honors data such as well data, seismic data, and conceptual geologic or depositional knowledge in creating the reservoir facies model.

I. Building a Training Image

A S-grid comprising layers and columns of cells is created to model a subsurface region wherein one or more reservoirs are to be modeled. The S-grid is composed of layers of a 3D grid strata-sliced (sliced following the vertical stratigraphic layers) thus dividing the grid into penecontemporanous layers (layers deposited at the same time in geologic terms). The grid is built from horizons and faults interpreted from seismic information, as well as from well markers.

A “training image,” which is a 3D rendering of the interpreted geological setting of the reservoir, is preferably built within the S-grid. However, the training image can be generated on a grid different from the S-grid. The training image is constructed based on stratigraphic input geometries that can be derived from seismic interpretation, outcrop data, or images hand drawn by a geologist.

Multiple-facies training images can be generated by combining objects according to user-specified spatial relationships between facies. Such relationships are based on depositional rules, such as the erosion of some facies by others, or the relative vertical and horizontal positioning of facies among each other.

FIGS. 3A and 3B illustrate a training image slice and a training image cross-section. The contrasting shades indicate differing facies types. The training images preferably do not contain absolute (only relative) spatial information and ideally need not be conditioned to wells.

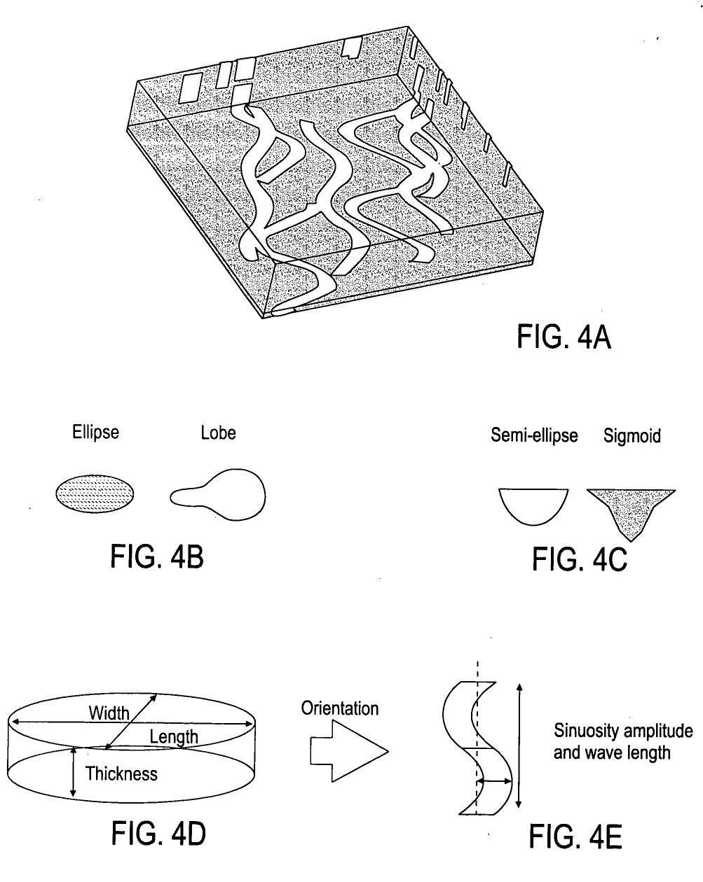

A straightforward way to create training images, such as is seen in FIG. 4A, consists of generating unconditional object-based simulated realizations using the following two-step process. First, a geologist provides a description of each depositional facies to be used in the model, except for a “background” facies, which is typically shale. This description includes the geometrical 3D shape of the facies geobodies, possibly defined by the combination of a 2D map shape and a 2D cross-section shape. For example, tidal sand bars could be modeled using an ellipsoid as the map view shape, and a sigmoid as the cross-section shape, as shown in FIGS. 4B and 4C.

The dimensions (length, width, and thickness) and the main orientation of the facies geobodies, as illustrated in FIG. 4D, are also selected. Instead of constant values, these parameters can be drawn from uniform, triangular or Gaussian distributions. FIG. 4E shows that sinuosity parameters, namely wave amplitude and wave length, may also be required for some types of facies elements such as channels.

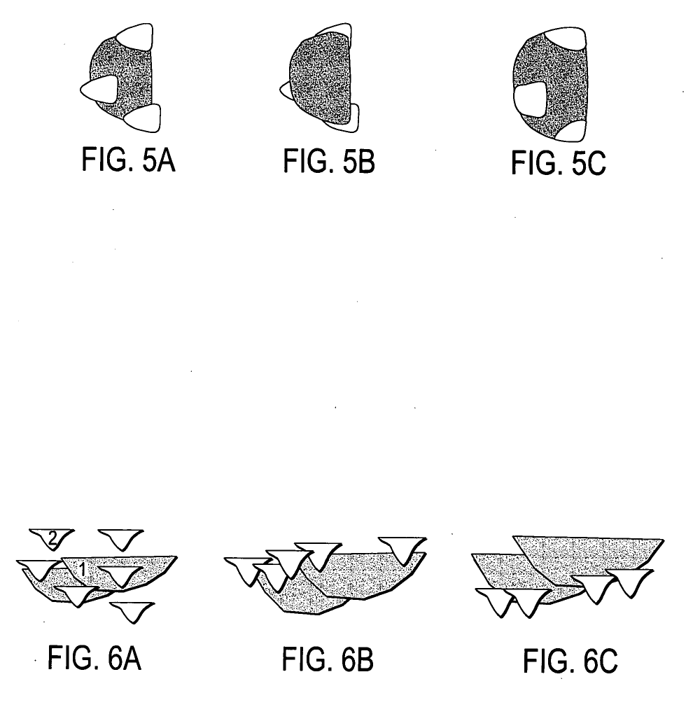

Further, relationship/rules between facies are defined. For example, in FIG. 5A, facies 2 is shown eroding facies 1. In contrast, FIG. 5B shows facies 2 being eroded by facies 1. In FIG. 5C, facies 2 is shown incorporated within facies 1.

FIGS. 6A-C depict vertical and/or horizontal constraints. In FIG. 6A, there are no vertical constraints. Facies 2 is shown to be constrained above facies 1 in FIG. 6B. Finally, in FIG. 6C, facies 2 is constrained below facies 1.

Those skilled in art of facies modeling will appreciate that other methods and tools can be used to create facies training images. In general, these facies training images are conducive to be used in pixel based algorithms for data conditioning.

II. Geologically-Interpreted Facies Probability Cube

A facies probability cube is created which is based upon geologic interpretations utilizing maps, logs, and cross-sections. This probability cube provides enhanced control on facies spatial distribution when creating a reservoir facies model. The facies probability cube is preferably generated on the 3D reservoir S-grid which is to be used to create the reservoir facies model. The facies probability cube includes the probabability of the occurrences of facies in each cell of the S-grid.

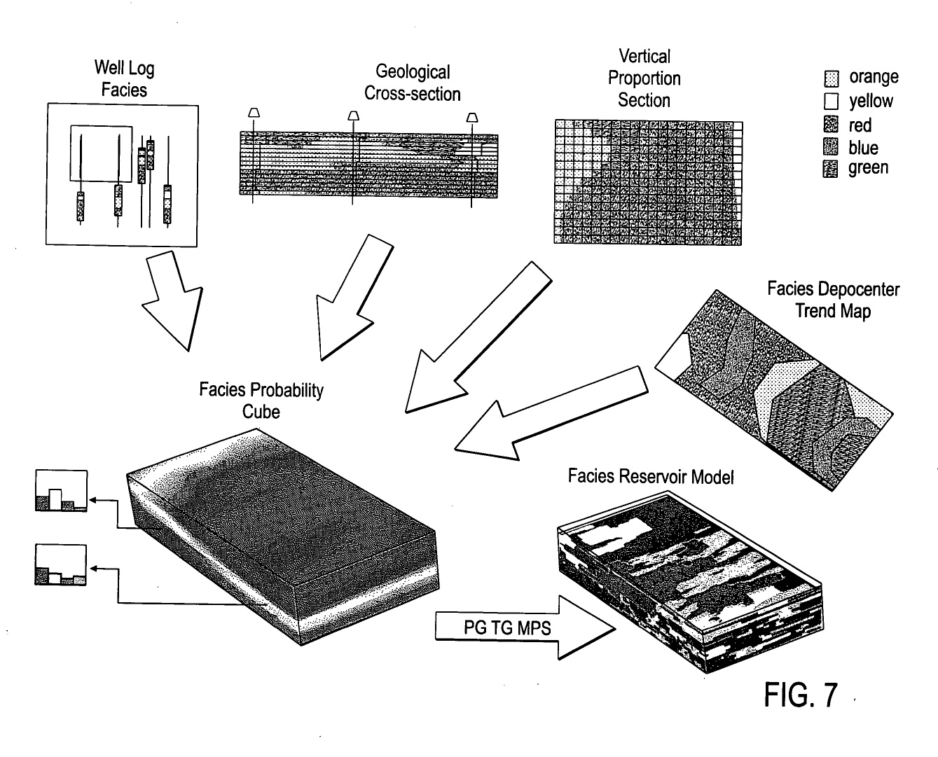

FIG. 7 shows that the facies probability cube is created from facies proportion data gathered using vertical and horizontal or map sections. In this preferred exemplary embodiment, the vertical sections are based upon well log facies, conceptual geologic cross-sections, and vertical proportion sections or graphs. Horizontal facies proportion data is derived using facies depocenter trend maps. Preferably, estimates of the probability of the presence of facies in the vertical and map views are generated from digitized sections showing facies trends. A modeler digitizes vertical and horizontal (map) sections to reflect facies knowledge from all available information including, but not limited to, data from well logs, outcrop data, cores, seismic, analogs and geological expertise. An algorithm is then used to combine the information from the vertical and horizontal sections to construct the facies probability cube. This facies probability cube, based largely on geological interpretation, can then be used in a geostatistical simulation to create a reservoir facies model.

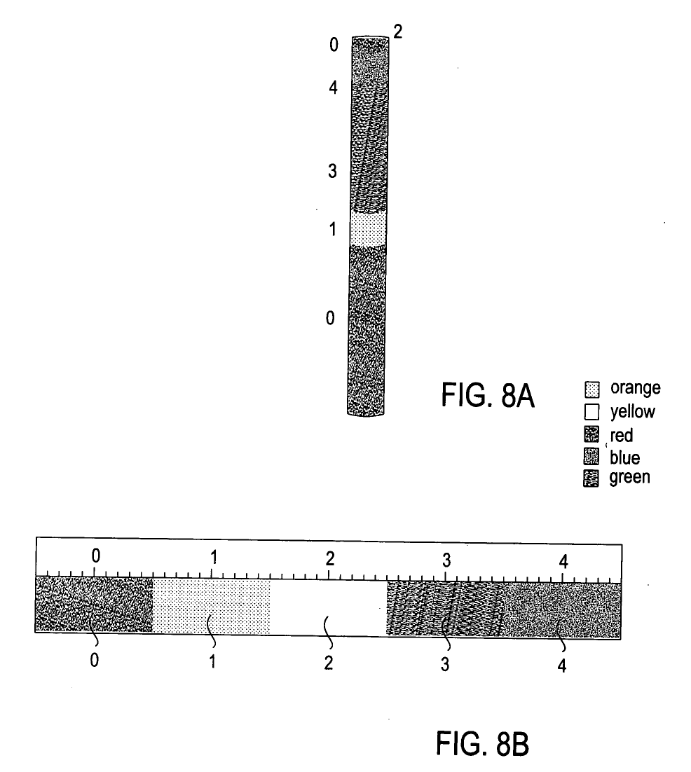

A select number of facies types for the subsurface region to be modeled are ideally determined from facies well log data. Utilizing too many facies types is not conducive to building a 3D model which is to be used in a reservoir simulation. The number of facies types used in a facies probability cube ordinarily ranges from 2 to 9, and more preferably, the model will have 4 to 6 facies types. In an exemplary embodiment to be described below there are five facies types selected from facies well log data. FIGS. 8A and 8B show a well with assigned facies types and a corresponding legend bar. These exemplary facies types include: 1) shale; 2) tidal bars; 3) tidal sand flats; 4) estuarine sand; and 5) transgressive lag. Of course, additional or different facies types may be selected depending upon the geological settings of the region being modeled.

Facies types for known well locations are then assigned to appropriately located cells within the S-grid. Since well logs are generally sampled at a finer scale (˜0.5 ft) than the S-grid (˜2-3 ft), a selection can be made as whether to use the most dominant well facies data in a given cell, or the well facies data point closest to the center of the cell. To preserve the probability of thin beds, it may be preferable to select the facies data point closest to the center of the cell.

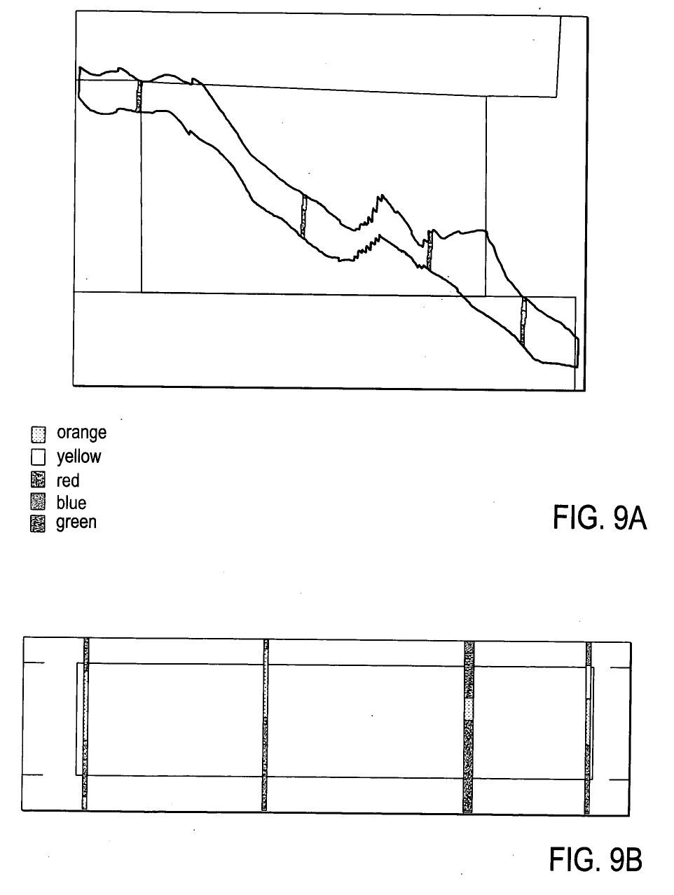

FIG. 9A illustrates an exemplary section with well facies data attached to the section. This particular section zigzags and intersects with four wells. The section can be flattened and straightened as seen in FIG. 9B. The flattened section makes the section easier to conceptualize and digitize. In particular, it may be desirable to flatten surfaces that are flooding surfaces. If a surface is erosional, then it may be preferable not to flatten the surface. In most cases, it is preferred to straighten the section.

The next step in this exemplary embodiment is to create a vertical geologic cross-section which captures the conceptual image of what the depositional model of the field might look like. A section may be selected along any orientation of the S-grid. Commonly, this section is selected to intersect with as many of the wells as possible. The line used to create the section may be straight or may zigzag.

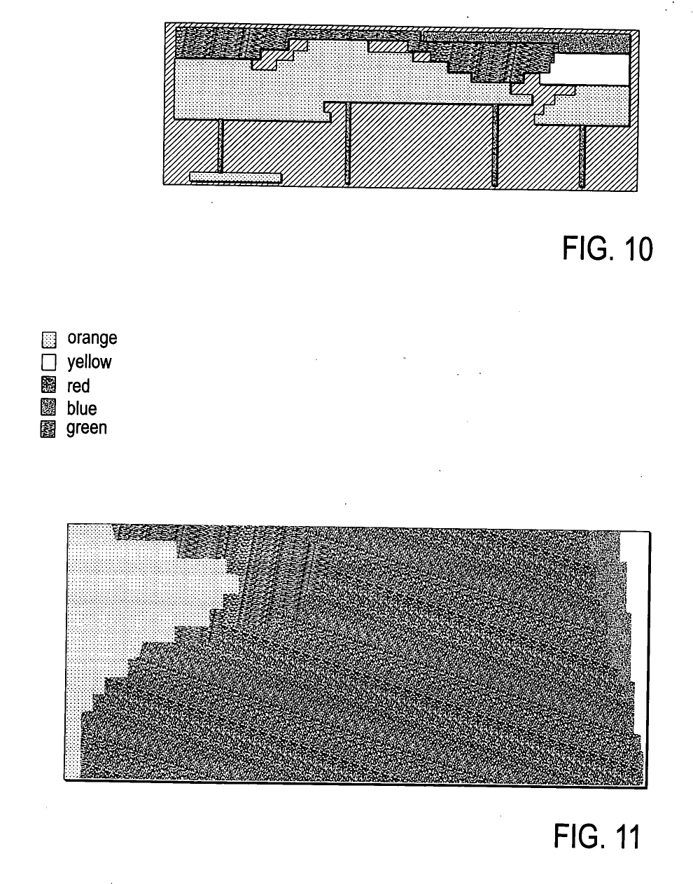

Depositional polygons are digitized upon a vertical S-grid section to create a geologic cross-section as shown in FIG. 10. The polygons are representative of the best estimate on that section of geological facies bodies. Factors which should be taken into account in determining how to digitize the depositional polygons include an understanding of the depositional setting, depositional facies shapes, and the relationship among depositional facies.

FIG. 11 shows a vertical “proportion section or graph”. This section is a function of the layer number used, whereby for each layer, the expected percentage of each facies type is specified. For each layer, all facies percentages should add to 100%. This proportion section provides an idea of how the proportions of each facies type tends to change through each layer of cells.

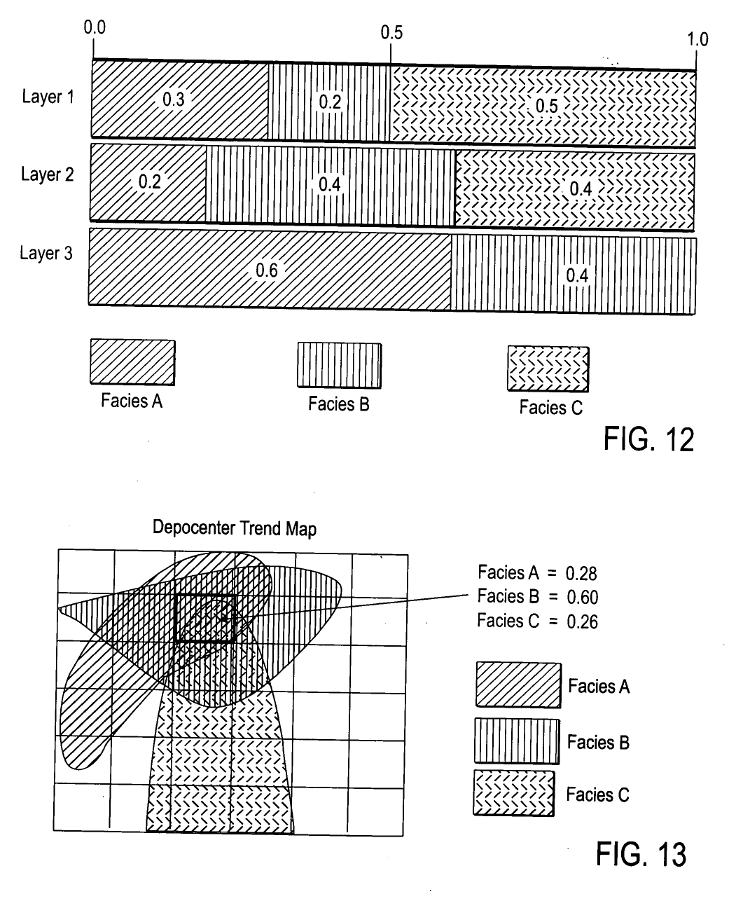

An overall or composite vertical proportion graph/data is then created from the individual proportion graphs or data. As described above, these graphs may be derived from facies well logs, conceptual geological sections, and general vertical proportion graphs. Each of these different vertical proportion graphs can be weighted in accordance with the certainty that that particular vertical proportion data accurately represents the vertical facies trends or distributions of facies. For example, if a well facies vertical section contains many wells and much well data, the corresponding proportion graph and data may be given a relative high weighting. Conversely, if only one or two wells are available, a proportion graph created from this well data may be given a low weighting. Similarly, where there is a high or low level of confidence in the facies trends in the vertical conceptual geologic section, a respective high or low weighting may be assigned to the related proportion graph. The weighted proportion graphs or data are then normalized to produce the composite vertical proportion graphs wherein the proportion of facies adds up to 100% in each layer. A simple example of a vertical proportion graph is shown in FIG. 12.

The next step is to create a depocenter map for each of the facies seen in FIG. 13. An areal 2D S-grid that matches dimensions of the top layer of the model 3D S-grid is utilized to build the depocenter map. One or more polygons are digitized on the 2D map to define a “depocenter region” likely containing a facies at some depth of the 3D S-grid. Depocenter regions do not need to be mutually exclusive but instead may overlap one another.

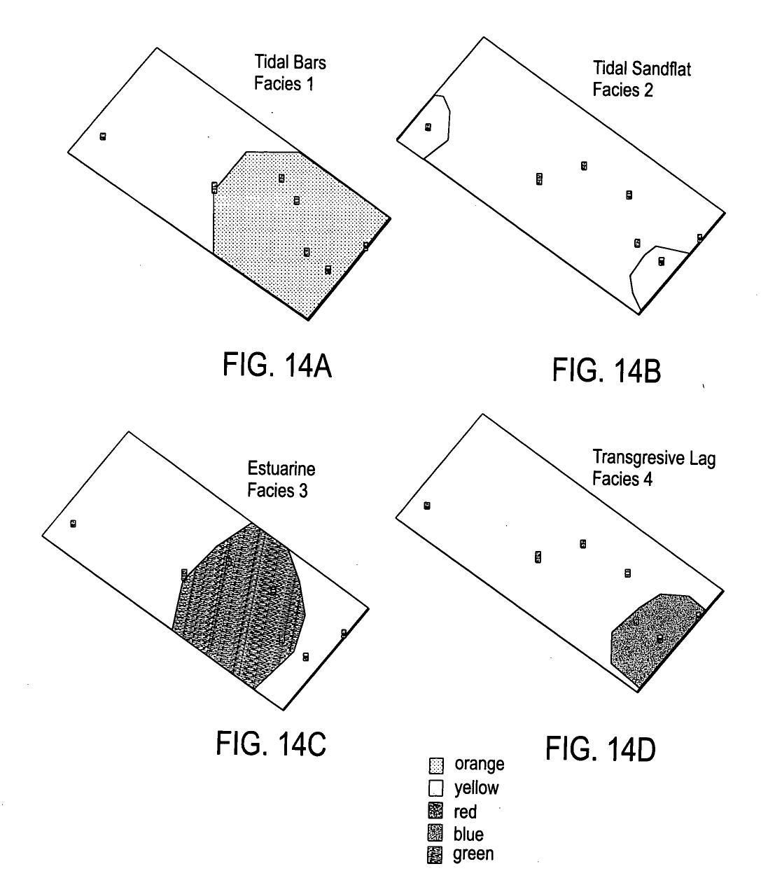

FIGS. 14A-D show the boundaries of four depocenter regions which have been digitized for four respective facies. A depocenter region can include the entire area of the map view, in which case no digitizing is necessary (this is referred to as background). In the central area of each polygon is a depocenter, which is the area beneath which one would expect the highest likelihood of the occurrence of a particular facies. A “truncation” region may also be digitized for each facies which defines an area where that facies is not thought to be present.

Ideally, each of the depocenter regions is independently drawn through digitization. While some consideration may be given to the presence of other facies in the S-grid, ideally a modeler will focus primarily on where it is believed that a particular facies will occur in the map view. This simplifies the creation of the combined overlapping depocenter map as shown in FIG. 13.

In contrast, conventional horizontal trends maps often rely upon simultaneously drawing and accounting for all the facies on a single horizontal section. Or else, conventionally simultaneous equations may be developed which describe the probability distribution of the facies across the horizontal map. The thought process in creating such horizontal trend maps is significantly more complex and challenging than individually focusing on creating depocenter maps for each individual facies.

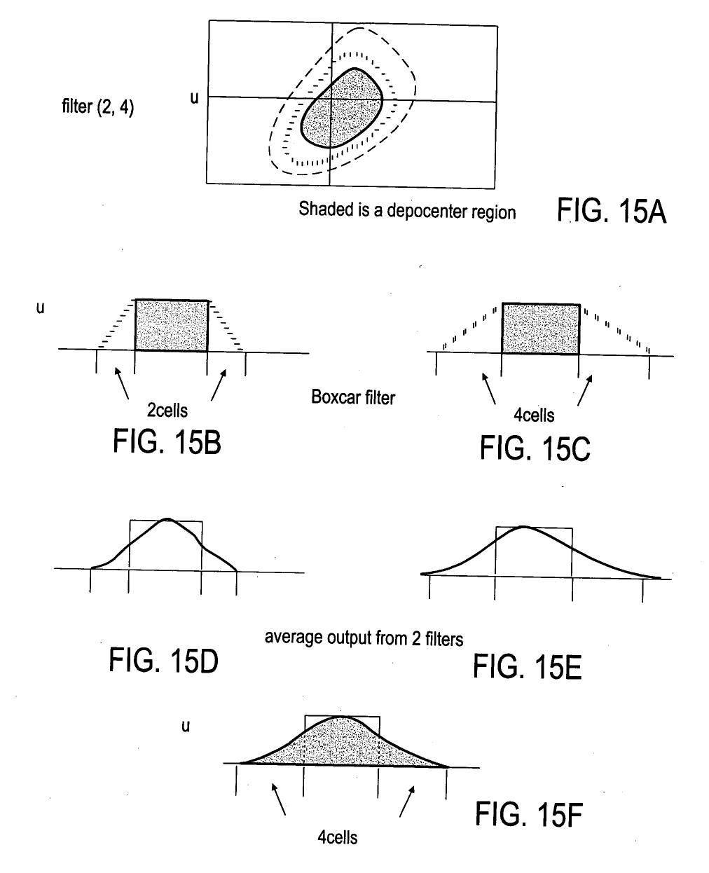

FIGS. 15A-F show a depocenter region which has been smoothed using a transition filter to distribute the probability of a facies occurring in columns of cells from a maximum to a minimum value. As shown in FIG. 15A, contour lines can be drawn to illustrate the relative level of probabilities as they decrease away from a depocenter. A shaded depocenter region is shown at the center of the map.

In this particular exemplary embodiment, a boxcar filter is used as the transition filter. Those skilled in the art will appreciate that many other types of filters or mathematical operations may also be used to smooth the probabilities across the depocenter region and map section. Probabilities decay away from the center region depending on the filter selected. A filter number of 2 requires the facies probabilities decay to 0 two cells from the edge or boundary of a digitized depocenter region, as seen in FIGS. 15B and 15D. Similarly, selecting a filter number of 4 will cause a decay from a boundary to 0 over 4 cells, as illustrated in FIGS. 15C and 15E. A filter number of 4-2 can be used to average the results of using a number 4 filter and a number 2 filter. FIG. 13 shows values (0.28, 0.60 and 0.26) for a particular column of cells after filtering operation have occurred on depocenter region for facies A, B and C.

The use of such transition filters enables a modeler to rapidly produce a number of different depocenter maps. The modeler simply changes one or more filter parameters to create a new depocenter map. Accordingly, a modeler can, by trial and error, select the most appropriate filter to create a particular facies depocenter map. The resulting depocenter map ideally will comport with facies information gathered from well log data as well other sources of facies information.

In another embodiment of this invention, an objective function can be used to establish which filter should be used to best match a depocenter map to known well facies data. A number of different filters can be used to create depocenter maps for a particular facies. The results of each depocenter map are then mathematically compared against well facies data. The filter which produces the minimum discrepancy between a corresponding depocenter map and the well log facies data is then selected for use in creating the facies probability cube.

In general, the areal depocenter trend map and data accounts for the likelihood of the occurrence of facies along columns or depth of the S-grid (See FIG. 13). In contrast, the vertical proportion graph/data relates to the likelihood that a facies will exist on some layer (See FIG. 12). The tendencies of a facies to exist at some (vertical) layer and in some (areal) depocenter region are combined to produce an overall estimate of the probabilities that facies exists in each cell of the S-grid. A preferred algorithm will be described below for combining the vertical proportion data and the map or horizontal proportion data to arrive at an overall facies probability cube for the S-grid. There are preferred constraints on this process. If a vertical proportion graph indicates that there should be 100% of a facies in a layer, or 0% facies in a layer, that value should not change when overall cell probabilities are calculated. A preferred process to accomplish this goal is to use a power law transformation to combine the vertical and horizontal proportion data (map). The power transformation law used in this example comports with the follow equation:

$$\frac{{\sum }_{l = 1}^{N} {[ {V}_{f} ( l ) ]}^{w ( l )}}{N} = {P}_{f} \qquad ( 1 )$$

where
l=a vertical layer index;
V_{ƒ}(l)=proportion of a facies ƒ in layer l;
P_{ƒ}=average probability for a facies ƒ in a column of cells;
w(l)=a power exponential; and
N=number of layers in the S-grid.

The following simplified example describes how the vertical and horizontal facies data are integrated. FIG. 12 illustrates a simple vertical proportion graph with three types of facies (A, B, and C). Note that the S-grid consists of three layers (N=3) and each layer has proportions (V_{ƒ}) of facies A, B, and C. The corresponding depocenter trend map is depicted in FIG. 13. Boundaries are drawn to establish initial depocenter regions for facies A, B and C. Subsequently, the smoothing of probabilities of facies A, B and C across the depocenter boundaries is performed using a filter, such as a boxcar filter. For the column of cells under consideration at a map location (x,y), the probabilities (P_{ƒ}) for the existence of facies A, B and C are determined to be 0.28, 0.60, and 0.26, respectively. These values from a filtering operation are not normalized in this example.

Based on the power transformation law of Equation (1) above, the following three equations are created for the three facies:

$$\frac{{0.3}^{w1} + {0.2}^{w1} + {0.6}^{w1}}{3} = 0.28$$

$$\frac{{0.2}^{w2} + {0.4}^{w2} + {0.4}^{w2}}{3} = 0.60$$

$$\frac{{0.5}^{w3} + {0.4}^{w3} + 0}{3} = 0.26$$

The equations are solved to produce w₁=1.3, w₂=0.45, and W₃=1.2.

The facies proportions are then computed along that column for each cell on a layer by layer basis.

| | Facies | Facies | Facies |
|---|---|---|---|
| Layer | A | B | C |
| 1 | 0.3^{1.3} | 0.2^{1.3} | 0.5^{1.3} |
| 2 | 0.2^{0.45} | 0.4^{0.45} | 0.4^{0.45} |
| 3 | 0.6^{1.2} | 0.4^{1.2} | 0.0 |

This results in the following values:

| | Facies | Facies | Facies |
|---|---|---|---|
| Layer | A | B | C |
| 1 | 0.209 | 0.123 | 0.406 |
| 2 | 0.485 | 0.662 | 0.662 |
| 3 | 0.542 | 0.333 | 0.000 |

After normalization, the facies proportions at each cell are:

| | Facies | Facies | Facies |
|---|---|---|---|
| Layer | A | B | C |
| 1 | 0.283 | 0.167 | 0.550 |
| 2 | 0.268 | 0.366 | 0.366 |
| 3 | 0.619 | 0.381 | 0.000 |

This process is repeated to determine the facies probabilities in all the cells of S-grid.

### Special Vertical Proportion Graphs

In certain instances the proportion of a facies in a column of cells may be significantly different from the proportion of that facies in a layer of cells. This disparity in proportions may occur if one or more facies is either dominant or minimal in a column of cells. In such cases, special weighted vertical proportion graphs can be used in calculating cell probabilities to provide a better correlation between vertical and horizontal proportion data for that column of cells.

A user ideally defines dominant and minimal threshold facies proportion limits for the columns of cells. For example, a user may specify that a column of cells has a dominant facies A if 90% or more of cells in that column contains facies A. Also, a user may specify a minimal facies threshold proportion limit, i.e., 15% or less. Alternatively, the dominant and minimal thresholds may be fixed in a computer program so that a user does not have to input these thresholds.

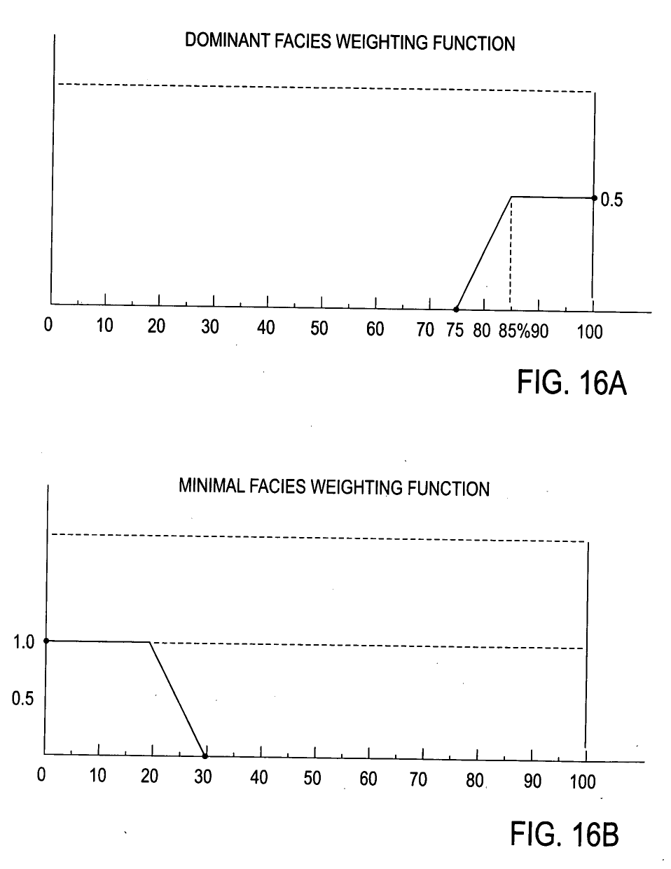

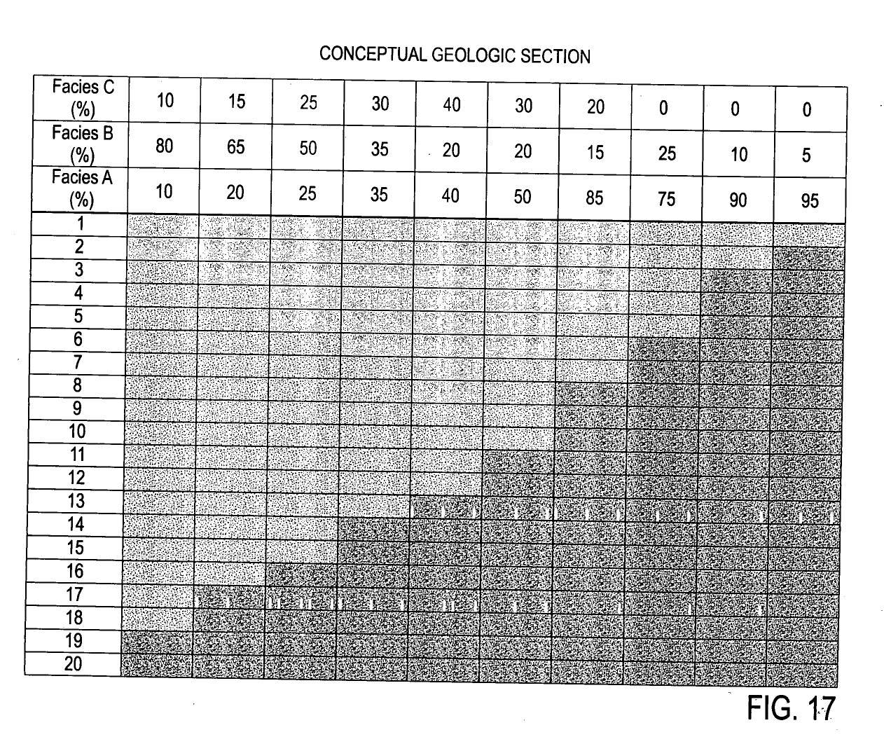

The special weighted vertical proportion graphs/data are created by using weighting functions to modify the proportions of a vertical section. Examples of such weighting functions are seen in FIGS. 16A-B. FIG. 16A shows a weighting function for use with dominant facies and FIG. 16B illustrates an exemplary weighting function for use with minimal facies. The vertical section may be a conceptual geologic cross-section, such as shown in FIG. 17.

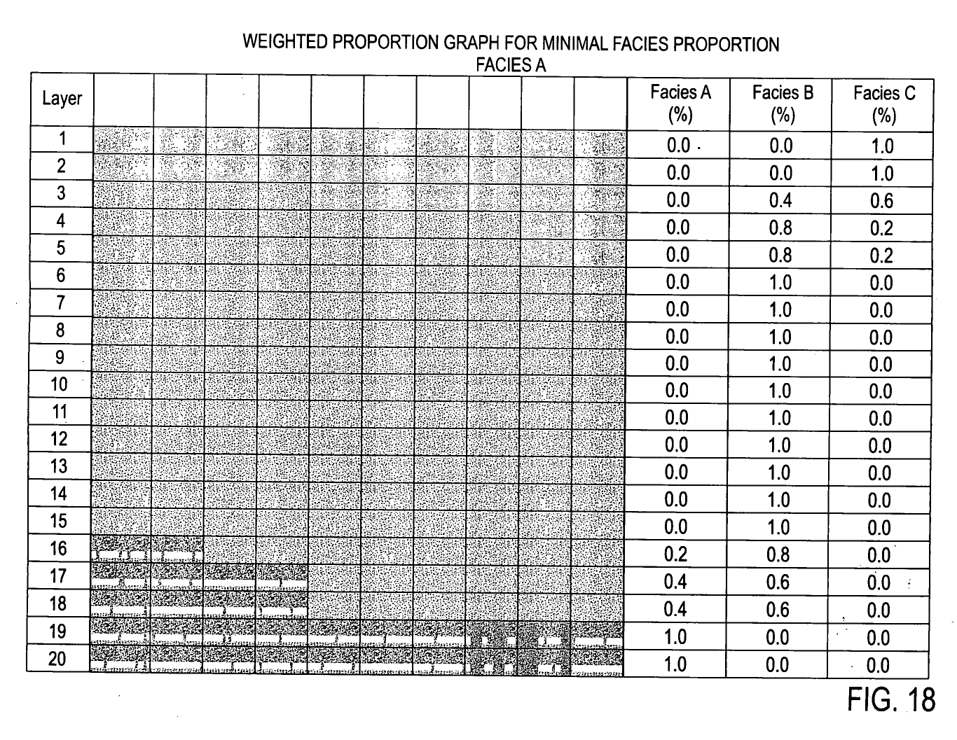

Ideally, weighted vertical proportion graphs are created for each of the minimal and dominant facies. For the section shown in FIG. 17, minimal and dominant weighted proportion graphs are created for each of facies A, B and C for a total of six weighted proportion graphs. The construction of a minimal weighted proportion graph for facies A will be described below. This exemplary proportion graph is shown in FIG. 18. The other proportion graphs are not shown but can be constructed in a manner similar to that of the proportion graph of FIG. 18.

Weighting functions are first defined and are shown in FIGS. 16A-B. In FIG. 16A, a dominant weighting function is shown which linearly ramps up from a value of 0.0 at 75% to a value of 1.0 at 85-100%. Weights are selected from the weighting function based upon the percentage of the particular facies found in each column of the vertical section for which the facies weighted proportion graph is to be constructed. For example, if the weighted proportion graph is to be constructed for facies A, then the percentage of facies A in each column will control the weight for that column.

FIG. 16B shows a weighting function for use with columns of cells having a minimal presence of a facies. In this case, a weight of 1.0 is assigned when the percentage of facies A in a column is from 0-20% and linearly declines to a value of 0.0 at 30%. Preferably, the weighting functions include a ramp portion to smoothly transition between values of 0.0 and 1.0. Of course, the aforementioned linear ramping portions of the weighting functions could also be non-linear in shape if so desired.

Weights from the weighting functions are applied to the proportion of the facies in the cells in each layer of the vertical section. The sum of the weighted proportions is then divided by the sum of the weights to arrive at a weighted facies proportion for a layer. More particularly, the facies are calculated according to the following equation:

$$\frac{\sum {w}_{c} \cdot {f}_{i}}{\sum {w}_{c}} = {V}_{f} ( l ) \qquad ( 2 )$$

where
w_{c}=weight for a particular column of cells;
ƒᵢ=1.0 where a facies f is present in a cell;
=0.0 where a facies f is not present in a cell;
Σw_{c}=sum of the weights in a layer of cells; and
V_{ƒ}(l)=proportion of a facies in a layer.

An example of how to determine proportion values for constructing a weighted proportion graph will be now be described. Looking to the first column of the vertical section in FIG. 17, the percentage of facies A in column 1 is 10%. Referring to the weighting graph of FIG. 16B, as 10% fall within the 20% threshold, a weight of 1.0 is assigned to this column. In column 2, the overall percentage of facies A is 20%. Again, this falls within the threshold of 20% so a full weight of 1.0 is assigned to column 2. In column 3, the percentage of facies A is 25%. The value of 25% falls within the linearly tapered region of the weighting function. Accordingly, a corresponding weight of 0.5 is selected for cells in column 3. For column 4, the percentage of facies A is 35%. As 35% is beyond the threshold of 30%, a weight of 0.0 is assigned to column 4. The remaining columns all contain in excess of 30% of facies A. Accordingly, all these columns are assigned a weight of 0.0. Therefore, only the first three columns are used in creating the vertical proportion graph for use when a minimal proportion of facies A is found in a column of cells from the depocenter map.

The weights for columns 1, 2 and 3, respectively, 1.0, 1.0 and 0.5, will be multiplied by the proportion of the facies in each cell. As each cell is assigned only one facies, the proportion will be 1.0 when a particular facies is present and 0.0 when that facies is not present. The following are exemplary calculations of facies proportion for several layers.

Layers 20 and 19, facies A:
(1.0×1.0+1.0×1.0+0.5×1.0)/(1.0+1.0+0.5)=1.0

Layers 20 and 19, facies B and C:
(1.0×0.0+1.0×0.0+0.5×0.0)/2.5=0.0

Layers 18 and 17, facies A:
(1.0×0.0+1.0×1.0+0.5×1.0)/2.5=0.6.

Layers 18 and 17, facies B:
(1.0×1.0+1.0×0.0+0.5×0.0)/2.5=0.4

Layers 18 and 17, facies C:
(1.0×0.0+1.0×0.0+0.5×0.0)/2.5=0.0

Layer 16, facies A:
(1.0×0.0+1.0×0.0+0.5×1.0)/2.5=0.2

Layer 16, facies B:
(1.0×1.0+1.0×1.0+0.5×0.0)/2.5=0.8

Layer 16, facies C:
(1.0×0.0+1.0×0.0+0.5×0.0)/2.5=0.0

Layer 3, facies A:
(1.0×0.0+1.0×0.0+0.5×0.0)/2.5=0.0

Layer 3, facies B:
(1.0×1.0+1.0×0.0+0.5×0.0)/2.5=0.4

Layer 3, facies C:
(1.0×0.0+1.0×1.0+0.5×1.0)/2.5=0.6

These calculations are carried out until the all the proportions for facies A, B and C are calculated for all the layers to create the weighted proportion graph for minimal facies A which is shown in FIG. 18. The process is repeated to create the other five weighted proportion graphs. These graphs will again use weights from the minimal and dominant weighting functions, determined from the percentages of the appropriate facies in the columns of the vertical section, which are then multiplied by the facies proportions in the cells and normalized by the sum of the weights. Again, vertical proportion values from these specially weighted proportion graphs will be used with Equation (1) to calculate cell probabilities for the facies probability cube.

The modeling of uncertainty in the spatial distribution of facies in an S-grid can be accomplished by changing geologic assumptions. For example, differing geological sections could be digitized to reflect different theories on how the geologic section might actual appear. Alternatively, different versions of the vertical proportion graph could be created to capture differing options about how the facies trends change from layer to layer across the S-grid. Similarly, a variety of differing depocenter maps could be used to capture the uncertainty in the distribution of facies in a map view of the S-grid. Further, different filters could be applied to depocenter regions to create alternative horizontal facies data, and ultimately, facies probability cubes.

III. Creating a Reservoir Facies Model Utilizing Training Images and Geologically Derived Facies Probability Cubes

The present invention segments geologic knowledge or information into a couple of distinct concepts during reservoir facies modeling. First, the use of training images captures facies information in terms of facies continuity, association, and heterogeneities. Second, using facies probability cubes which are generated using conceptual geologic estimates or interpretations regarding depositional geology enhances the relative connectivity and spatial knowledge regarding facies present in a reservoir facies model.

Uncertainty may be accounted for in the present invention by utilizing several different training images in combination with a single facies probability cube. The different training images can be built based upon uncertainties in concepts used to create the different training images. The resulting facies reservoir models from the MPS simulation using the single facies probability cube and the various training images then captures uncertainty in the reservoir facies model due to the different concepts used in creating the training images. Conversely, numerous MPS simulations can be conducted using a single training image and numerous facies probability cubes which were generated using different geologic concepts as to the spatial distribution of the facies in a S-grid. Hence, uncertainty related to facies continuity, association, and heterogeneities can be captured using a variety of training images while uncertainties associated with the relative spatial distribution of those facies in the S-grid model can determined through using multiple facies probability cubes.

Reservoir facies models in this preferred embodiment are made in manner comparable with that described by Caers, J., Strebelle, S., and Payrazyan, K., Stochastic Integration of Seismic Data and Geologic Scenarios: A West Africa Submarine Channel Saga, The Leading Edge, March 2003. As provided above, this paper describes how seismically derived facies probability cubes can be used to further enhance conventional MPS simulation in creating reservoir facies models. The present invention utilizes geologically derived facies probability cubes as opposed to using seismically derived facies probability cubes. This provides the advantage of integrating geological information from reservoir analogies and removing seismic data artifacts.

The training image and the geologically derived facies probability cube are used in a geostatistical simulation to create a reservoir facies model. The preferred geostatistical methodology to be used in the present invention is multiple point geostatistics. It is also within the scope of this invention to use other geostatistical methodologies in conjuction with training images and geologically derived facies probability cubes to construct reservoir facies models having enhanced facies distributions and continuity. By way of example and not limitation, such geostatistical methodologies might include PG (plurigaussian) or TG (truncated guassian) simulations as well as MPS simulations.

The MPS simulation program SNESIM (Single Normal Equation Simulation) is preferably used to generate multiple-point geostatistical facies models that reproduce the facies patterns displayed by the training image, while honoring the hard conditioning well data. SNESIM uses a sequential simulation paradigm wherein the simulation grid cells are visited one single time along a random path. Once simulated, a cell value becomes a hard datum that will condition the simulation of the cells visited later in the sequence. At each unsampled cell, the probability of occurrence of any facies A conditioned to the data event B constituted jointly by the n closest facies data, is inferred from the training image by simple counting: the facies probability P(A|B), which identifies the probability ratio P(A,B)/P(B) according to Bayes' relation, can be obtained by dividing the number of occurrences of the joint event {A and B} (P(A,B)) by the number of occurrences of the event B (P(B)) in the training image. A facies value is then randomly drawn from the resulting conditional facies probability distribution using Monte-Carlo simulation, and assigned to the grid cell. Monte-Carlo sampling process is well-known to statisticians. It consists of drawing a random value between 0 and 1, and selecting the corresponding quantile value from the probability distribution to be sampled.

SNESIM is well known to those skilled in the art of facies and reservoir modeling. In particular, SNESIM is described in Strebelle, S., 2002, Conditional Simulation of Complex Geological Structures Using Multiple-Point Statistics: Mathematical Geology, V. 34, No. 1; Strebelle, S., 2000, Sequential Simulation of Complex Geological Structures Using Multiple-Point Statistics, doctoral thesis, Stanford University. The basic SNESIM code is also available at the website http://pangea.stanford.edu/˜strebell/research.html. Also included at the website is the PowerPoint presentation senesimtheory.ppt which provides the theory behind SNESIM, and includes various case studies. PowerPoint presentation senesimprogram.ppt provides guidance through the underlying SNESIM code. Again, these publications are well-known to facies modelers who employ multiple point statistics in creating facies and reservoir models. These publications are hereby incorporated in there entirety by reference.

The present invention extends the SNESIM program to incorporate a geologically-derived probability cube. At each unsampled grid cell, the conditional facies probability P(A|B) is updated to account for the local facies probability P(A|C) provided by the geologically-derived probability cube. That updating is preferably performed using the permanence of ratios formula described in Journel, A. G., 2003, p. 583, Combining Knowledge From Diverse Sources: An Alternative to Traditional Data Independence Hypotheses, Mathematical Geology, Vol. 34, No. 5, July 2002, p. 573-596. This teachings of this reference is hereby incorporated by reference in its entirety.

Consider the logistic-type ratio of marginal probability of A:

$$a = \frac{1 - P ( A )}{P ( A )}$$

$$Similarly$$

$$b = \frac{1 - P ( A \vert B )}{P ( A \vert B )} , c = \frac{1 - P ( A \vert C )}{P ( A \vert C )} , x = \frac{1 - P ( A \vert B , C )}{P ( A \vert B )}$$

where
P(A|B,C)=the updated probability of facies A given the training image information and the geologically-derived facies probability cube.

The permanence of ratio amounts to assuming that:

$$\frac{x}{b} ≅ \frac{c}{a}$$

As described by Journel, this suggests that “the incremental contribution of data event C to knowledge of A is the same after or before knowing B.”

The conditional probability is then calculated as

$$P ( A \vert B , C ) , = \frac{1}{1 + x} = \frac{a}{a + bc} ∈ [ 0 , 1 ]$$

One advantage of using this formula is that it prevents order relation issues: all the corrected facies probabilities are between 0 and 1, and they sum up to 1. A facies is then randomly drawn by using a Monte-Carlo simulation from the resulting updated facies probability distribution to populate the cells of the S-grid.

The end result is a reservoir model having cells populated with properties such as as porosity, permeability, and water saturation. Such a reservoir model may then be used with a reservoir simulator. Such commercial reservoir simulators include Schlumberger's ECLIPSE® simulator, or ChevronTexaco CHEARS® simulator.

While in the foregoing specification this invention has been described in relation to certain preferred embodiments thereof, and many details have been set forth for purposes of illustration, it will be apparent to those skilled in the art that the invention is susceptible to alteration and that certain other details described herein can vary considerably without departing from the basic principles of the invention.

What is claimed is:

1. A method for creating a reservoir facies model comprising:
(a) creating a S-grid representative of a subterranean region to be modeled;
(b) creating a training image that includes a plurality of facies;
(c) creating a facies probability cube, corresponding to the S-grid, which is derived from a geological interpretation of the facies distribution within the subterranean region; and
(d) performing a geostatistical simulation that utilizes the training image and facies probability cube to create a reservoir facies model.

2. The method of claim 1 wherein:
the geostatistical simulation is a multiple-point simulation.

3. The method of claim 1 wherein:
the geostatistical simulation derives probabilities from the training image and those probabilities are combined with probabilities from the facies probability cube using a permanence of ratio methodology.

4. The method of claim 1 wherein:
additional geostatistical simulations are performed using different facies probability cubes to capture a range of uncertainty in the distribution of the facies.

5. The method of claim 1 wherein:
additional geostatistical simulations are performed using different training models to capture a range of uncertainty in the distribution of the facies.

6. The method of claim 1 wherein:
the facies probability cube is created using an areal depocenter map of the facies which identifies probable locations of facies within the S-grid.
